(19) United States
(12) Patent Application Publication
(10) Pub. No.: US 2026/0318353 A1
(43) Pub. Date: Oct. 15, 2026

(54) ANGULAR BALL BEARING

(71) Applicant: NTN CORPORATION, OSAKA (JP)

(72) Inventor: Shouhei OKA, Kuwana-shi (JP)

(73) Assignee: NTN CORPORATION, OSAKA (JP)

(21) Appl. No.: 19/687,484

(22) Filed: May 26, 2026

Related U.S. Application Data
(63) Continuation of application No. PCT/JP2024/041209, filed on Nov. 21, 2024.

(30) Foreign Application Priority Data
Nov. 27, 2023 (JP) 2023-200059

(51) Int. Cl. F16C 19/16; F16C 33/38

(52) U.S. Cl. CPC F16C 19/163; F16C 33/38; F16C 2240/34; F16C 2240/46; F16C 2240/60; F16C 2240/70; F16C 2360/00

(57) ABSTRACT

Provided is an angular ball bearing that includes an inner ring, an outer ring, a plurality of balls and a retainer. The retainer includes a counterbore part of the inner ring, a small annular part positioned between the counterbore part of the inner ring and a shoulder part of the outer ring in a radial direction, a large annular part positioned between the counterbore part of the outer ring and a shoulder part of the inner ring in the radial direction, and a plurality of pillar portions connecting the small annular part and the large annular part. The angular ball bearing satisfies: 0.170≤T1/Da≤0.280, 0.170≤T2/Da≤0.280, 0.90≤T1/T2≤1.10, where T1 represents a radial thickness of the small annular part, T2 represents a radial thickness of the large annular part, and Da represents a ball diameter.

### CROSS REFERENCE TO THE RELATED APPLICATION

This application is a continuation application, under 35 U.S.C. § 111 (a) of international patent application No. PCT/JP2024/041209, filed Nov. 21, 2024, which claims priority to Japanese patent application No. 2023-200059, filed Nov. 27, 2023, the entire disclosures of all of which are herein incorporated by reference as a part of this application.

### FIELD OF THE INVENTION

The present invention relates to an angular ball bearing used in, for example, a compressor, a pump, an injection molding machine, and/or the like.

### BACKGROUND ART

Patent Document 1 discloses an angular ball bearing that does not generate abnormal noise, vibration, or temperature rise and satisfies a relationship defined with respect to internal design of the bearing.

### RELATED DOCUMENT

### Patent Document

[Patent Document 1] JP Laid-open Patent Publication No. 2022-24610

### SUMMARY OF THE INVENTION

### Problems to be Solved by the Invention

Angular ball bearings used in compressors, pumps, injection molding machines, and the like are required to have high load capacity and to rotate at a high speed.

In the conventional angular ball bearings, a pocket gap A of a retainer 50 is managed as illustrated in FIG. 5 not to cause abnormal noise, vibration, or temperature rise. Meanwhile, when the angular ball bearing is used under a condition of high load capacity and of high-speed rotation, the retainer is also subjected to a high load. The retainer therefore needs to have strength of a certain level or higher.

An object of the present invention is to provide an angular ball bearing having a longer service life by ensuring strength of a certain level or higher for the retainer even under a condition of high load capacity and of high-speed rotation.

### Means for Solving the Problems

An angular ball bearing of the present invention is an angular ball bearing including an inner ring and an outer ring each having a counterbore part, a plurality of balls interposed between the inner ring and the outer ring, and a retainer that retains the balls.

The retainer includes a small annular part positioned between the counterbore part of the inner ring and a shoulder part of the outer ring in a radial direction, a large annular part positioned between the counterbore part of the outer ring and a shoulder part of the inner ring in the radial direction, and pillar portions provided at a plurality of positions in a circumferential direction, connecting the small annular part and the large annular part, and the small annular part, the large annular part, and the pillar portions form pockets for retaining the plurality of balls.

The angular ball bearing satisfies:

0.170≤T1/Da≤0.280

0.170≤T2/Da≤0.280

0.90≤T1/T2≤1.10
where T1 represents a radial thickness of the small annular part, T2 represents a radial thickness of the large annular part, and Da represents a diameter of each of the balls.

The symbol T1 refers to the radial thickness in an axially outward portion of the small annular part.

The symbol T2 refers to the radial thickness in an axially outward portion of the large annular part.

The shoulder part of the outer ring is an inner peripheral portion on the back face side of the outer ring.

The shoulder part of the inner ring is an outer peripheral portion on the back face side of the inner ring.

According to this configuration, the retainer having a left-right asymmetric cross section has a configuration in which the value T1/Da obtained by dividing the radial thickness T1 of the small annular part by the diameter Da of each of the balls and the value T2/Da obtained by dividing the radial thickness T2 of the large annular part by the diameter Da of each of the balls fall within the above ranges. As a result, the retainer is ensured to have strength of a certain level or higher, and the retainer can be prevented from interfering with at least one bearing ring of the inner and outer rings.

In addition, by managing a value T1/T2 obtained by dividing the radial thickness T1 of the small annular part by the radial thickness T2 of the large annular part to fall within the above range, a good balance can be maintained between the thickness of the small annular part and the thickness of the large annular part, thereby enabling whirling or the like of the retainer that may occur during high-speed rotation to be prevented. Accordingly, the retainer can be ensured to have strength of a certain level or higher even under a condition of high load capacity and of high-speed rotation, and the angular ball bearing can therefore have a longer service life.

When the contact angle is 30 degrees or more and 45 degrees or less, the following relationship may hold, where D represents the outer diameter of the outer ring, and d represents the inner diameter of the inner ring.

0.62≤2Da/(D−d)≤0.80

When the contact angle is 30 degrees or more and 45 degrees or less, a load capacity can be achieved that is higher than that of an angular ball bearing having a contact angle of, for example, 15 degrees or 25 degrees. In addition, from the above relational expression, a ball is used that has a relatively large diameter Da with respect to the outer diameter D of the outer ring and the inner diameter d of the inner ring. This enables the angular ball bearing to have even higher load capacity.

The following relationships may hold, where A is a radial gap between a surface of each of the pockets of the retainer facing the ball and a ball surface, and PCD represents a pitch circle diameter of the ball, in a state where the axial center axis of the entire angular ball bearing and the axial center axis of the retainer are aligned with each other.

A/Da≤0.020

2A/PCD≤0.010

In this case, by appropriately adjusting the gap A with respect to the diameter Da and the pitch circle diameter PCD of each of the balls, the movement amount of the retainer during operation of the angular ball bearing becomes appropriate. This ensures the stability of the retainer during bearing operation. Controlling the gap A as described above prevents occurrence of a speed difference between the inner ring and the outer ring and the ball. This is because rotation of the ball is not hindered and the rotation speed of the ball does not decrease. Therefore, occurrence of abnormal noise, vibration, and temperature rise that may be generated between the inner ring and the outer ring and the ball due to a speed difference between the inner ring, the outer ring, and the ball can be stably reduced or prevented.

The following relationship may hold, where T3 represents a pillar width, which is a circumferential width of the pillar portion, and PCD represents the pitch circle diameter of the ball.

0.01≤T3/PCD≤0.05

When a value T3/PCD obtained by dividing the pillar width T3 by the pitch circle diameter PCD is less than 0.01, the strength of the retainer may be insufficient. When the value T3/PCD is greater than 0.05, the load capacity may be small. By setting the value T3/PCD to fall within the above range, the retainer is ensured to have sufficient strength, and an angular ball bearing can be provided without reducing the ball diameter or reducing the number of balls.

Any combination of at least two configurations disclosed in the appended claims and/or the specification and/or the drawings is included within the scope of the present invention. In particular, any combination of two or more of the claims described in the appended claims is included within the scope of the present invention.

### BRIEF DESCRIPTION OF THE DRAWINGS

The present invention will be more clearly understood from the following description of a preferred embodiment with reference to the accompanying drawings. However, the embodiment and the drawings are merely illustrative and explanatory, and should not be utilized to define the scope of the present invention. The scope of the present invention is to be determined by the appended claims. In the accompanying drawings, like reference characters in the drawings indicate the same or corresponding parts.

FIG. 1 is a longitudinal sectional view of an angular ball bearing according to a first embodiment of the present invention.

FIG. 2 is a perspective view of a retainer of the angular ball bearing.

FIG. 3 is an enlarged cross-sectional view of a main part of the retainer.

FIG. 4 is a partial cross-sectional view of the retainer taken along a plane perpendicular to the axial direction.

FIG. 5 is a partially enlarged cross-sectional view of a retainer in a conventional angular ball bearing.

### DESCRIPTION OF EMBODIMENTS

### First Embodiment

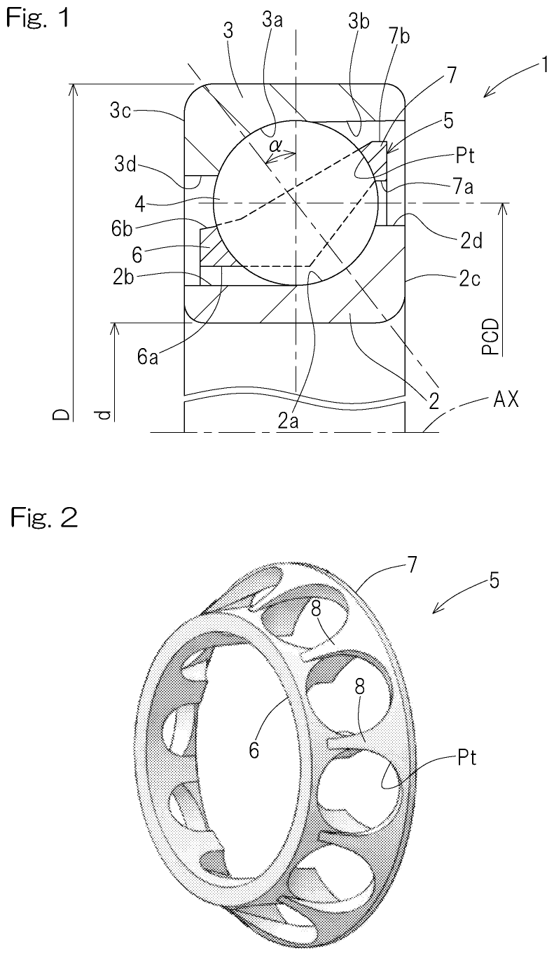

An angular ball bearing according to an embodiment of the present invention will be described with reference to FIGS. 1 to 4. This angular ball bearing is used in, for example, a compressor, a pump, an injection molding machine, and/or the like. However, the angular ball bearing is not limited to one for use in these applications, and can be applied to various industrial machines and the like. The angular ball bearing may herein be simply referred to as “bearing”.

### <Overall Structure of Angular Ball Bearing>

As illustrated in FIG. 1, an angular ball bearing 1 includes an inner ring 2 and an outer ring 3, which are bearing rings, a plurality of balls 4 interposed between a raceway surface 2a of the inner ring 2 and a raceway surface 3a of the outer ring 3, and a retainer 5, which forms a pocket Pt for retaining each corresponding one of the balls 4. A contact angle α is generated on the raceway surfaces 2a and 3a of the inner and outer rings 2 and 3.

The inner and outer rings 2 and 3 are made of, for example, high carbon chromium bearing steel such as SUJ2, martensitic stainless steel, or the like. The balls 4 are made of, for example, steel balls, ceramics, or the like. The retainer 5 is formed in an annular shape from, for example, a resin or the like such as nylon, PPS, PEEK, or a phenol resin each reinforced with glass fiber, carbon fiber, or the like.

The term “axial direction” as used herein refers to a direction along a bearing center line AX of the angular ball bearing 1. The term “radial direction” as used herein refers to a direction orthogonal to a straight line parallel to the “axial direction”.

The raceway surface 3a is connected to a front face of the outer ring 3 via a counterbore part 3b (described later). The front face of the outer ring 3 is a side face on a side on which an axial load is not to be supported. A back face 3c of the outer ring 3 is a side face on a side on which the axial load is to be supported. A shoulder part 3d, which is the inner peripheral surface on the back face side of the outer ring 3, is positioned radially inward with respect to the counterbore part 3b of the outer ring 3. The raceway surface 2a is connected to a front face of the inner ring 2 via a counterbore part 2b (described later). The front face of the inner ring 2 is a side face on a side on which an axial load is not to be supported. A back face 2c of the inner ring 2 is a side face on a side on which the axial load is to be supported. The inner peripheral surface on the back face side of the inner ring 2 is referred to as a shoulder part 2d. The shoulder part 2d is formed between the raceway surface 2a of the inner ring 2 and the back face 2c of the inner ring 2. The shoulder part 2d of the inner ring 2 is positioned radially outward with respect to the counterbore part 2b of the inner ring 2.

The shoulder part 3d of the outer ring 3 is formed in a cylinder surface shape parallel to the axial direction. The counterbore part 3b of the outer ring 3 is formed in a cylinder surface shape or in a tapered surface shape formed to have a larger diameter of a predetermined dimension at a position radially outward with respect to the shoulder part 3d, and is also referred to as “counterbored part” of the outer ring 3. The tapered surface is a tapered surface inclined radially inward along a direction from the outer ring front face side toward the raceway surface 3a. The shoulder part 2d of the inner ring 2 is formed in a cylinder surface shape parallel to the axial direction. The counterbore part 2b of the inner ring 2 is formed in a cylinder surface shape or in a tapered surface shape formed to have a smaller diameter of a predetermined dimension at a position radially inward with respect to the shoulder part 2d, and is also referred to as “counterbored part” of the inner ring 2. The tapered surface is a tapered surface inclined radially outward along a direction from the inner ring front face side toward the raceway surface 2a.

### <Retainer>

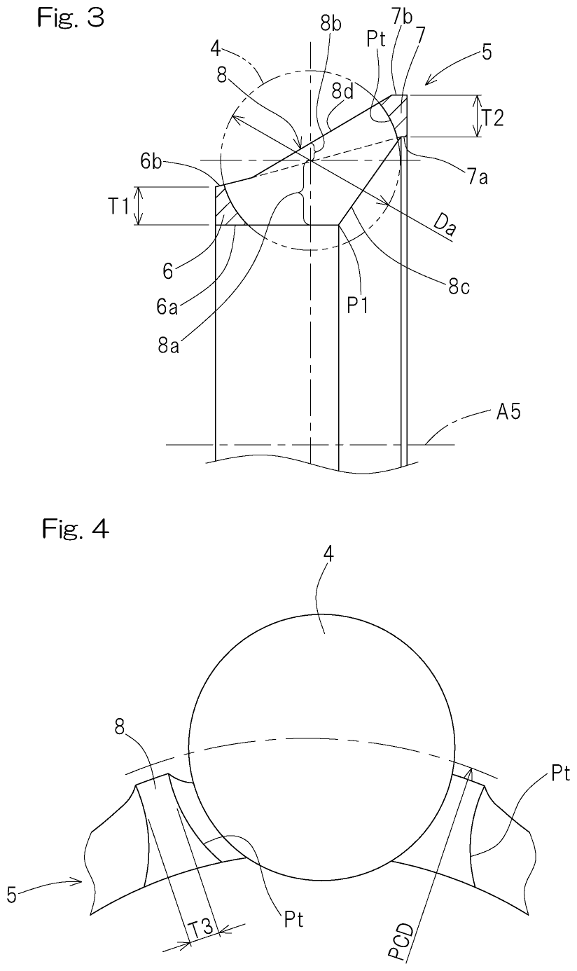

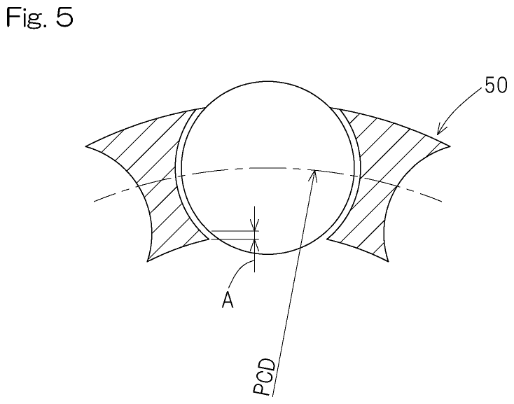

As illustrated in FIGS. 2 and 3, the retainer 5 includes a small annular part 6, a large annular part 7, and pillar portions 8. This retainer 5 is independently tradable in the market. As illustrated in FIG. 1, the small annular part 6 is accommodated between the counterbore part 2b of the inner ring 2 and the shoulder part 3d of the outer ring 3. The large annular part 7 is accommodated between the counterbore part 3b of the outer ring 3 and the shoulder part 2d of the inner ring 2. As illustrated in FIG. 3, the large annular part 7 is positioned radially outward with respect to the small annular part 6. The pillar portions 8 are provided at a plurality of positions in the circumferential direction to connect the small annular part 6 and the large annular part 7.

The small annular part 6, the large annular part 7, and the pillar portions 8 form the pockets Pt for retaining the plurality of balls 4. The small annular part 6, the large annular part 7, and the pillar portions 8 are formed integrally. The term “integrally” means that the small annular part 6, the large annular part 7, and the pillar portions 8 are not formed by combining a plurality of elements, but formed as a part or whole of a single object by, for example, injection molding or the like.

The pillar portions 8 have inner diameter side pillar portions 8a and outer diameter side pillar portions 8b. The inner diameter side pillar portions 8a extend between the small annular part 6 and the large annular part 7 generally along the axial direction from the small annular part 6 toward the large annular part 7. The outer diameter side pillar portions 8b extend between the small annular part 6 and the large annular part 7 generally along the axial direction from the large annular part 7 toward the small annular part 6. The inner diameter side pillar portions 8a each have a first inclined surface 8c formed on the right side in FIG. 3, which is the side closer to the large annular part. The first inclined surface 8c is an inclined surface that is inclined radially outward along a direction toward the bearing front face side, and reaches the large annular part 7.

As illustrated in FIG. 1, the small annular part 6 has a first inner peripheral surface 6a and a first outer peripheral surface 6b. The first inner peripheral surface 6a is a surface of the small annular part 6 on the side closest to the inner ring 2. The first outer peripheral surface 6b is a surface of the small annular part 6 on the side closest to the outer ring 3, and is positioned radially inward with respect to the pitch circle diameter PCD of each of the balls 4.

The large annular part 7 has a second inner peripheral surface 7a and a second outer peripheral surface 7b. The second inner peripheral surface 7a is a surface of the large annular part 7 on the side closest to the inner ring 2, and is positioned radially outward with respect to the pitch circle diameter PCD of each of the balls 4. The second outer peripheral surface 7b is a surface of the large annular part 7 on the side closest to the outer ring 3. As illustrated in FIG. 3, the first inclined surface 8c is connected from an end portion P1 on the large annular part side flush with the first inner peripheral surface 6a to the second inner peripheral surface 7a of the large annular part 7. The outer diameter side pillar portions 8b each have a second inclined surface 8d, which is an inclined surface that is inclined radially outward along a direction toward the bearing front face side, and reaches the large annular part 7.

### Parameters and Operational Effects

The results of the step-up test described later have shown, with respect to the angular ball bearing described above, that the retainer 5 is ensured to have strength of a certain level or higher thereby preventing the bearing rings and the retainer 5 from interfering with each other even under a condition of high load capacity and of high-speed rotation when Formulas (1), (2), and (3) below are all satisfied, where T1 represents the radial thickness of the small annular part 6, T2 represents the radial thickness of the large annular part 7, and Da represents the diameter of each of the balls 4. Note that details of the high load capacity and the high-speed rotation are appropriately determined according to the application, the use conditions, and the like of the angular ball bearing.

0.170≤T1/Da≤0.280 Formula (1)

0.170≤T2/Da≤0.280 Formula (2)

0.90≤T1/T2≤1.10 Formula (3)

The retainer having a left-right asymmetric cross section has a configuration in which the value T1/Da obtained by dividing the radial thickness T1 of the small annular part 6 by the diameter Da of each of the balls 4 and the value T2/Da obtained by dividing the radial thickness T2 of the large annular part 7 by the diameter Da of each of the balls 4 fall within the ranges of Formulas (1) and (2) above. As a result, the retainer 5 is ensured to have strength of a certain level or higher, and the retainer 5 can be prevented from interfering with at least one bearing ring of the inner and outer rings.

In addition, by managing a value T1/T2 obtained by dividing the radial thickness T1 of the small annular part 6 by the radial thickness T2 of the large annular part 7 to fall within the range of Formula (3) above, a good balance can be maintained between the thickness of the small annular part 6 and the thickness of the large annular part 7, thereby enabling whirling or the like of the retainer 5 that may occur during high-speed rotation to be prevented. Accordingly, the retainer 5 can be ensured to have strength of a certain level or higher even under a condition of high load capacity and of high-speed rotation, and the angular ball bearing can therefore have a longer service life.

As illustrated in FIG. 1, when the contact angle α is 30 degrees or more and degrees or less, the following relational expression (4) is preferably satisfied with respect to the angular ball bearing 1, where D represents the outer diameter of the outer ring 3, and d represents the inner diameter of the inner ring 2.

0.62≤2Da/(D−d)≤0.80 Formula (4)

When the contact angle α is 30 degrees or more and 45 degrees or less, a load capacity can be achieved that is higher than that of an angular ball bearing having a contact angle α of, for example, 15 degrees or 25 degrees. In addition, from the above relational expression (4), a ball 4 is used that has a relatively large diameter Da with respect to the outer diameter D of the outer ring 3 and the inner diameter d of the inner ring 2. This enables the angular ball bearing 1 to have even higher load capacity.

Formulas (5) and (6) preferably hold with respect to the angular ball bearing 1 described above, where A is a radial gap between a surface of each of the pockets Pt of the retainer 5 facing the ball 4 and a ball surface, and PCD represents a pitch circle diameter of the ball 4, in a state where the axial center axis of the entire angular ball bearing and an axial center axis A5 (FIG. 3) of the retainer 5 are aligned with each other.

A/Da≤0.020 Formula (5)

2A/PCD≤0.010 Formula (6)

In this case, by appropriately adjusting the gap A with respect to the diameter Da and the pitch circle diameter PCD of each of the balls 4, the movement amount of the retainer 5 during operation of the angular ball bearing 1 becomes appropriate. This ensures the stability of the retainer 5 during bearing operation. Controlling the gap A as described above prevents occurrence of a speed difference between the inner ring 2 and the outer ring 3 and the ball 4. This is because rotation of the ball 4 is not hindered and the rotation speed of the ball 4 does not decrease. Therefore, occurrence of abnormal noise, vibration, and temperature rise that may be generated between the inner ring 2 and the outer ring 3 and the ball 4 due to a speed difference between the inner ring 2, the outer ring 3, and the ball 4 can be stably reduced or prevented.

As illustrated in FIG. 4, the following relational expression (7) preferably holds with respect to the angular ball bearing, where T3 represents the pillar width, which is a circumferential width of each of the pillar portions, and PCD represents the pitch circle diameter of each of the balls 4.

0.01≤T3/PCD≤0.05 Formula (7)

When a value T3/PCD obtained by dividing the pillar width T3 by the pitch circle diameter PCD is less than 0.01, the strength of the retainer 5 may be insufficient. When the value T3/PCD is greater than 0.05, the load capacity may be small. By setting the value T3/PCD to fall within the above range, the retainer 5 is ensured to have sufficient strength, and an angular ball bearing can be provided without reducing the ball diameter or reducing the number of balls.

### <Step-Up Test>

A step-up test was performed on the allowable rotation speed using an example and a comparative example.

### 1. Test Bearing

Equivalent to model number 7308B (inner diameter φ40 mm×outer diameter φ90 mm×width 23 mm, contact angle 40°)

In both the comparative example and the example, 7308B was used to form a combined angular ball bearing in a back-to-back arrangement.
Equivalent to model number 7210B (inner diameter φ50 mm×outer diameter φ90 mm×width 20 mm, contact angle 40°)

In both the comparative example and the example, 7210B was used to form a combined angular ball bearing in a back-to-back arrangement.

### 2. Test Conditions

Preload: Back-to-back arrangement, constant preload at 2 kN

Lubrication: Circulating oil supply, grease

Rotation speed: 2000 to 10000 min⁻¹ (stepped up in steps of 1000 min⁻¹) Stop of test: Until the temperature of the outer ring, which was a fixed ring, reached 70° C.

Operation time: Circulating oil supply . . . 20 min each, grease . . . 60 min each

3. Test results

Operations were successfully performed without abnormal noise, temperature rise, or abnormal heat generation in the comparative example and the example.

The bearing equivalent to model number 7308B in the example has generated less heat than that in the comparative example, and has achieved 10% increase in allowable rotation speed with respect to the comparative example.

The relationship between the ratio of T1/Da and T2/Da, and the strength of the retainer and the interference with the bearing ring is shown in Table 1 below.

TABLE 1
Relationship between ratio of T1/Da and T2/Da, and strength
of retainer and interference with bearing ring

| | Insufficiency of | Interference with |
|---|---|---|
| | strength of retainer | bearing ring |
| 0.150 | X | ◯ |
| 0.160 | Δ | ◯ |
| 0.170 | ◯ | ◯ |
| 0.180 | ◯ | ◯ |
| 0.190 | ◯ | ◯ |
| 0.200 | ◯ | ◯ |
| 0.210 | ◯ | ◯ |
| 0.220 | ◯ | ◯ |
| 0.230 | ◯ | ◯ |
| 0.240 | ◯ | ◯ |
| 0.250 | ◯ | ◯ |
| 0.260 | ◯ | ◯ |
| 0.270 | ◯ | ◯ |
| 0.280 | ◯ | ◯ |
| 0.290 | ◯ | Δ |
| 0.300 | ◯ | X |

In Table 1, in the column of insufficiency of strength of retainer, ∘ indicates that the retainer is ensured to have sufficient strength, Δ indicates that there is a problem in the strength of the retainer, and x indicates that the strength of the retainer is insufficient. In the column of interference with the bearing ring, ∘ indicates that the retainer and the bearing ring do not interfere with each other, Δ indicates that the retainer and the bearing ring may interfere with each other, and x indicates that the retainer and the bearing ring interfere with each other.

According to Table 1, when T1/Da or T2/Da is less than 0.170, problem of insufficient strength of the retainer is a concern. When T1/Da or T2/Da is greater than 0.280, interference between the retainer and the bearing ring is a concern.

The relationship between T3/PCD, and the strength of the retainer and a decrease in the load capacity is shown in Table 2 below.

TABLE 2
Relationship between T3/PCD, and strength
of retainer and decrease in load capacity

| | Insufficiency of | Decrease in load |
|---|---|---|
| | strength of retainer | capacity |
| 0.005 | X | ◯ |
| 0.010 | Δ | ◯ |
| 0.015 | ◯ | ◯ |
| 0.020 | ◯ | ◯ |
| 0.025 | ◯ | ◯ |
| 0.030 | ◯ | ◯ |
| 0.035 | ◯ | ◯ |
| 0.040 | ◯ | ◯ |
| 0.045 | ◯ | ◯ |
| 0.050 | ◯ | Δ |
| 0.055 | ◯ | X |

In Table 2, in the column of insufficiency of strength of retainer, ∘ indicates that the retainer is ensured to have sufficient strength, Δ indicates that there is a problem in the strength of the retainer, and x indicates that the strength of the retainer is insufficient. In the column of decrease in load capacity, ∘ indicates that the load capacity is necessary and sufficient, Δ indicates that the load capacity may decrease but is sufficient for implementation, and × indicates that the load capacity decreases.

According to Table 2, when T3/PCD is less than 0.01, problem of insufficient strength of the retainer is a concern. When T3/PCD is greater than 0.05, it is necessary to reduce the ball diameter or the number of balls, and thus, there is a concern about a decrease in load capacity.

### Other Embodiments

The angular ball bearing 1 of FIG. 1 described above can be used in a double-row configuration not only in a back-to-back arrangement but also in a face-to-face or tandem arrangement, and can also be used in a single-row configuration.

The retainer 5 may be formed by injection molding and machining in combination, or can also be formed using a 3D printer or the like.

A preferred embodiment has been described above with reference to the drawings. However, various additions, modifications, and deletions can be made within a range not departing from the spirit of the present invention. Accordingly, such variations are also within the scope of the present invention.

### REFERENCE SIGNS LIST

1 . . . Angular ball bearing
2 . . . nner ring
2b . . . Counterbore part
2d . . . Shoulder part
3 . . . Outer ring
3b . . . Counterbore part
3d . . . Shoulder part
4 . . . . Ball
5 . . . Retainer
6 . . . Small annular part
7 . . . Large annular part
8 . . . . Pillar portion
Pt . . . Pocket
α . . . Contact angle
PCD . . . Pitch circle diameter

What is claimed is:

1. An angular ball bearing comprising an inner ring and an outer ring each having a counterbore part, a plurality of balls interposed between the inner ring and the outer ring, and a retainer that retains the balls, wherein
the retainer includes a small annular part positioned between the counterbore part of the inner ring and a shoulder part of the outer ring in a radial direction, a large annular part positioned between the counterbore part of the outer ring and a shoulder part of the inner ring in the radial direction, and pillar portions provided at a plurality of positions in a circumferential direction, the pillar portions connecting the small annular part and the large annular part, and the small annular part, the large annular part, and the pillar portions form pockets for retaining the plurality of balls, and
the angular ball bearing satisfies:
0.170≤T1/Da≤0.280
0.170≤T2/Da≤0.280
0.90≤T1/T2≤1.10
where T1 represents a radial thickness of the small annular part, T2 represents a radial thickness of the large annular part, and Da represents a diameter of each of the balls.

2. The angular ball bearing according to claim 1, wherein a following relationship holds when a contact angle is 30 degrees or more and 45 degrees or less:
0.62≤2Da/(D−d)≤0.80
where D represents an outer diameter of the outer ring, and d represents an inner diameter of the inner ring.

3. The angular ball bearing according to claim 1, wherein following relationships hold:
A/Da≤0.020
2A/PCD≤0.010
where A is a radial gap between a surface of each of the pockets of the retainer facing a corresponding one of the balls and a ball surface, and PCD represents a pitch circle diameter of each of the balls, in a state where an axial center axis of the entire angular ball bearing and an axial center axis of the retainer are aligned with each other.

4. The angular ball bearing according to claim 1, wherein a following relationship holds:
0.01≤T3/PCD≤0.05
where T3 represents a pillar width, the pillar width being a circumferential width of each of the pillar portions, and PCD represents a pitch circle diameter of each of the balls.
